(19) United States
(12) Patent Application Publication
(10) Pub. No.: US 2002/0167537 A1
(43) Pub. Date: Nov. 14, 2002

(54) Motion-based tracking with pan-tilt-zoom camera

(76) Inventor: Miroslav Trajkovic, Ossining, NY (US)

Correspondence Address: Corporate Patent Counsel, U.S. Philips Corporation, 580 White Plains Road, Tarrytown, NY, 10591, US

(21) Appl. No.: 09/854,119

(22) Filed: May 11, 2001

(51) Int. Cl. G09G 5/00

(52) U.S. Cl. 345/649

(57) ABSTRACT

A motion-estimation scheme is provided that employs a combination of motion estimation and compensation techniques. Low resolution images are computed from two consecutive image frames, and feature points are determined and matched between the two low resolution images. Statistical methods are used to estimate the motion in terms of a translation and rotation of the image plane. Corresponding feature points in the original images are matched, based on the estimated motion of the low-resolution images. Statistical techniques are then applied to determine a homography matrix that describes the motion between the corresponding feature points in the original images, and this matrix is used to align the original images. Differences between the aligned images are identified, to indicate the movement of one or more objects in the image.

### BACKGROUND OF THE INVENTION

1. Field of the Invention

This invention relates to the field of image processing, and in particular to the tracking of target objects in images provided from a non-stationary camera.

2. Description of Related Art

Motion-based tracking is commonly used to track particular objects within a series of image frames. For example, security systems can be configured to process images from one or more cameras, to autonomously detect potential intruders into secured areas, and to provide appropriate alarm notifications based on the intruder's path of movement. Similarly, videoconferencing systems can be configured to automatically track a selected speaker, or a home automation system can be configured to track occupants and to correspondingly control lights and appliances in dependence upon each occupant's location.

A variety of motion-based tracking techniques are available for use with static cameras. An image from a static camera will provide a substantially constant background image, upon which moving objects form a dynamic foreground image. With a fixed field of view, motion-based tracking is a fairly straightforward process. The background image is ignored, and the foreground image is processed to identify individual objects with the foreground image. Criteria such as object size, shape, color, etc. can be used to distinguish objects of potential interest, and pattern matching techniques can be applied to track the motion of the same object from frame to frame in the series of images from the camera.

Object tracking can be further enhanced by allowing the tracking system to control one or more cameras having an adjustable field-of-view, such as cameras having an adjustable pan, tilt, and/or zoom capability. For example, when an object that conforms to a particular set of criteria is detected within an image, the camera is adjusted to keep the object within the camera's field of view. In a multi-camera system, the tracking system can be configured to “hand-off” the tracking process from camera to camera, based on the path that the object takes. For example, if the object approaches a door to a room, a camera within the room can be adjusted so that its field of view includes the door, to detect the object as it enters the room, and to subsequently continue to track the object.

As the camera's field of view is adjusted, the background image “appears” to move, making it difficult to distinguish the actual movement of foreground objects from the apparent movement of background objects. If the camera control is coupled to the tracking system, the images can be pre-processed to compensate for the apparent movements that are caused by the changing field of view, thereby allowing for the identification of foreground image motion.

If the tracking system is unaware of the camera's changing field of view, image processing techniques can be applied to detect the motion of each object within the sequence of images, and to associated the common movement of objects to an apparent movement of the background objects caused by a change of the camera's field of view. Movements that differ from this common movement are then associated to objects that form the foreground images. This estimation of the changing camera's field of view based on the movement of objects within a series of images can lead to anomalies, or artifacts, as background objects are mistakenly interpreted to be moving foreground objects, and as foreground objects that are traveling in the same direction as the common movement are mistakenly interpreted to be stationary background objects. Because of these artifacts, conventional field of view estimating techniques are limited to relatively small and/or predictable camera motion.

### BRIEF SUMMARY OF THE INVENTION

It is an object of this invention to provide motion-based tracking that compensates for unknown and/or uncontrolled changes of a camera's field of view, with minimal camera-motion-based artifacts. It is a further object of this invention to provide motion-based tracking that allows for substantial changes in the camera's field of view.

These objects and others are achieved by providing a motion-estimation scheme that employs a combination of motion estimation and compensation techniques. Low resolution images are computed from two consecutive image frames, and feature points are determined and matched between the two low resolution images. Statistical methods are used to estimate the motion in terms of a translation and rotation of the image plane. Corresponding feature points in the original images are matched, based on the estimated motion of the low-resolution images. Statistical techniques are then applied to determine a homography matrix that describes the motion between the corresponding feature points in the original images, and this matrix is used to align the original images. Differences between the aligned images are identified, to indicate the movement of one or more objects in the image.

### BRIEF DESCRIPTION OF THE DRAWINGS

The invention is explained in further detail, and by way of example, with reference to the accompanying drawings wherein:

FIG. 1 illustrates an example flow diagram of an image tracking system in accordance with this invention.

FIG. 2 illustrates an example block diagram of an image tracking system in accordance with this invention.

FIG. 3 illustrates an example flow diagram for image alignment in accordance with this invention.

Throughout the drawings, the same reference numerals indicate similar or corresponding features or functions.

### DETAILED DESCRIPTION OF THE INVENTION

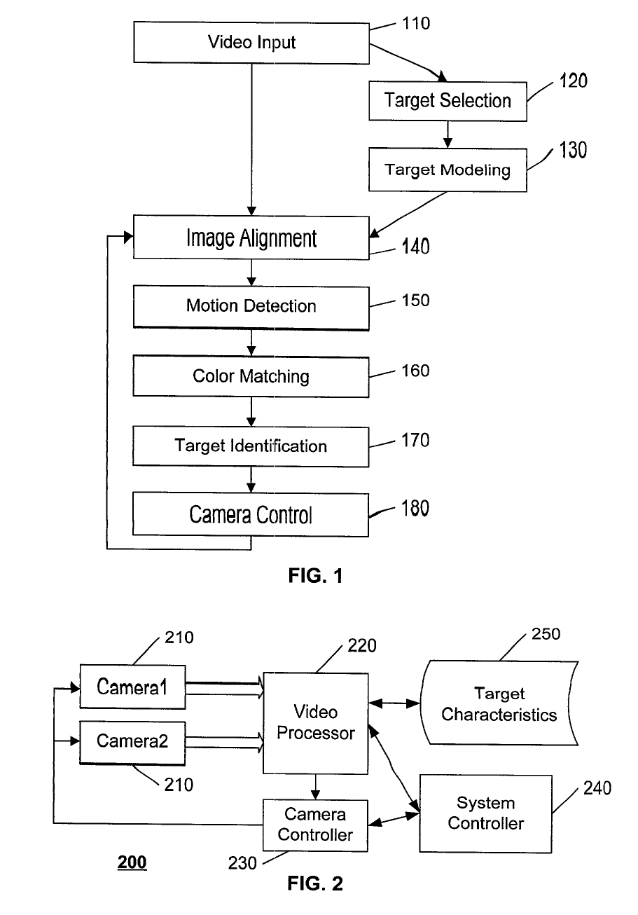

FIG. 1 illustrates an example flow diagram of an image tracking system in accordance with this invention. Video input, in the form of image frames is continually received, at 110, and continually processed, via the image processing loop 140-180. At some point, either automatically or based on manual input, a target is selected for tracking within the image frames, at 120. After the target is identified, it is modeled for efficient processing, at 130. At block 140, the current image is aligned to a prior image, taking into account any camera adjustments that may have been made, at block 180. After aligning the prior and past images in the image frames, the motion of objects within the frame is determined, at 150. Generally, a target that is being tracked is a moving target, and the identification of independently moving objects improves the efficiency of locating the target, by ignoring background detail. At 160, color matching is used to identify the portion of the image, or the portion of the moving objects in the image, corresponding to the target. Based on the color matching and/or other criteria, such as size, shape, speed of movement, etc., the target is identified in the image, at 170.

In an integrated security system, the tracking of a target generally includes controlling one or more cameras to facilitate the tracking, at 180. In a multi-camera system, the target tracking system, determines when to “hand-off” the tracking from one camera to another, for example, when the target travels from one camera's field of view to another. In either a single or multi-camera system, the target tracking system may also be configure to adjust the camera's field of view, via control of the camera's pan, tilt, and zoom controls, if any. Alternatively, or additionally, the target tracking system may be configured to notify a security person of the movements of the target, for a manual control of the camera, or selection of cameras. Preferably, the control of the camera's field of view is configured to maintain a fixed focal distance to the target, thereby maintaining the target image at substantially the same size, regardless of the distance of the target from the camera.

As would be evident to one of ordinary skill in the art, a particular tracking system may contain fewer or more functional blocks than those illustrated in the example system of FIG. 1. For example, a system that is configured to merely detect motion, without regard to a specific target, need not include the target selection and modeling blocks 120, 130, nor the color matching and target identification blocks 160, 170. Alternatively, to minimize false-alarms, such a system may be configured to provide a “general” description of a potential targets, such as a minimum size or a particular shape, in the target modeling block 130, and detect such a target in the target identification block 170. In like manner, a system may be configured to ignore particular targets, or target types, based on general or specific modeling parameters.

Not illustrated, the target tracking system may be configured to effect other operations as well. For example, in a security application, the tracking system may be configured to activate audible alarms if the target enters a secured zone, or to send an alert to a remote security force, and so on. In a home-automation application, the tracking system may be configured to turn appliances and lights on or off in dependence upon an occupant's path of motion, and so on.

The tracking system is preferably embodied as a combination of hardware devices and programmed processors. FIG. 2 illustrates an example block diagram of an image tracking system 200 in accordance with this invention. One or more cameras 210 provide input to a video processor 220. The video processor 220 processes the images from one or more cameras 210, and, if configured for target identification, stores target characteristics in a memory 250, under the control of a system controller 240. In a preferred embodiment, the system controller 240 also facilitates control of the fields of view of the cameras 210, and select functions of the video processor 220. As noted above the tracking system 200 may control the cameras 210 automatically, based on tracking information that is provided by the video processor 220.

This invention primarily relates to the image alignment 140 and motion detection 150 tasks of FIG. 1. Although systems are known that provide image alignment based on controlled camera motion, such system generally require fairly slow camera movement, or long dwell times on the same image, to overcome the lag-time delays generally associated with controlled camera movement. The subject invention is presented herein without regard to whether the camera's motion is controlled, although one of ordinary skill in the art would recognize that this invention can be used in conjunction with controlled camera systems and processing methods, to improve the accuracy of the alignment.

As is known in the art, the mapping of coordinates from an image of from one camera field of view to another field of view is given by:

\overline{p}′=M\overline{p},

where M is defined as the homography matrix that maps (aligns) the first image to the second image. This equation may be written as:

$${x}^{′} = \frac{{m}_{11} x + {m}_{12} y + {m}_{13}}{{m}_{31} x + {m}_{32} y + {m}_{33}}$$

$${y}^{′} = \frac{{m}_{21} x + {m}_{22} y + {m}_{23}}{{m}_{31} x + {m}_{32} y + {m}_{33}}$$

where (x′, y′) is a coordinate pair of a point in one of the images corresponding to the same point at (x, y) in another image. For ease of continual tracking, alignment is typically effected by aligning the prior image to the current image, so as to minimize redundant processing and/or accumulated errors. The matrix terms m₁₁ through m₃₃ are dependent upon the change of camera settings between images I1 and I2. A unity-diagonal matrix (m₁₁=m₂₂=m₃₃=1; all others=0) corresponds to no change in the camera field of view between images. If the camera settings are known, and the camera is calibrated to provide a correspondence between settings and field of view parameters, the matrix terms can be calculated directly. To do so, however, the precise camera settings at the time that each of the images were obtained must be known.

In accordance with this invention, recognizing that the precise camera settings at the time of each image are generally not available, or not timely available, the nine¹ matrix terms m₁₁ through m₃₃ are estimated, based on a plurality of corresponding coordinates (x′,y′) and (x,y) in each of the images. One of the difficulties in estimating the parameters is that the above equations related to the correspondence between stationary points whose image coordinates change because of camera motion, whereas some of the points in the image are actually moving relative to the stationary background. If the coordinates of the moving points are used, the estimated matrix terms will be biased, because the motion of the point will be interpreted as a motion of the camera. Preferably, the algorithm that is used to estimate the matrix terms corresponding to the potentially changing fields of view of the camera between images should distinguish between the points that are real-world-stationary from points that are real-world-moving. In a preferred embodiment of this invention, the RANSAC algorithm, common in the art, is used. The RANSAC algorithm identifies and ignores “outliers”, points in a set of sample point that are inconsistent with most of the other points in the set. Assuming that most of the points in an image are stationary, the outliers will correspond to real-world-moving points, while the non-outliers will correspond to the real-world-stationary points. Thus, using the RANSAC 1 The estimation of the N terms requires a computational determination of N−1 terms, the remaining N^{th} term being defined by the estimated N−1 terms.

algorithm, the estimated matrix terms that are based on the non-outliers will correspond to the movement, if any, of the real-world-stationary points between the images, and this movement will correspond to the changing camera fields of view between the images.

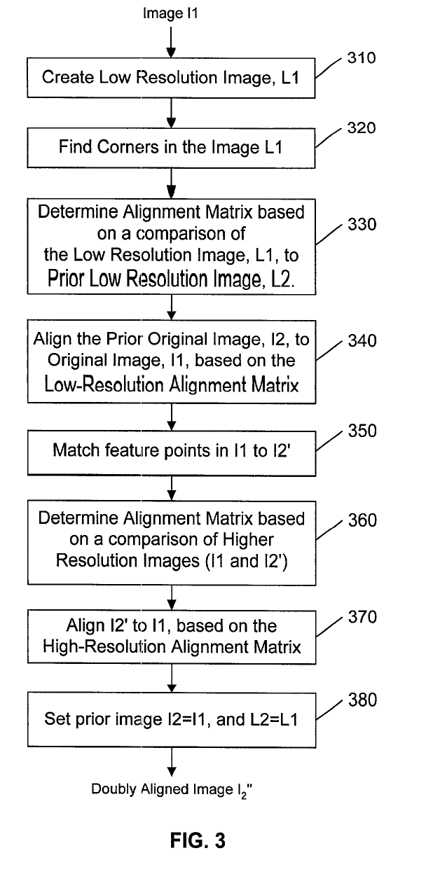

FIG. 3 illustrates an example flow diagram for image alignment of a current image I1 with a prior image I2. In accordance with one aspect of this invention, a low resolution image L1 is created for the current image I1, at 310, and distinguishable corners are identified in this low resolution current image L1, at 320. A low resolution image L2 of the prior image I2 will have been created, at 310, and distinguishable corners located, at 320, when the prior image I2 was processed. At 330 the alignment of the images is determined by aligning the distinguishable corners in the low resolution images L1 and L2. Any of a variety of alignment determination schemes may be used, but, because the images are low resolution, this alignment is a coarse alignment, and a simple, low precision, alignment determination process is preferably employed, to facilitate a fast determination of this coarse alignment.

To determine the coarse alignment, the transformation of coordinates is approximated by a rotation and a translation, as follows;

x′=x cosα+y sin α+tₛ=a₁x−a₂y+tₓ

y′=x sinα+y cos α+t_{y}=a₂x+a₁y+t_{y},

where the angle α corresponds to the image changes caused by an angular rotation of the camera, tₓ and t_{y} correspond to the image changes caused by a lateral movement of the camera, and a1=cos α and a2=sin α. Note that a change of zoom settings is not explicitly accounted for in this coarse approximation. A change of zoom setting is often indistinguishable between sequential images of a typical video camera. If the change of zoom setting is to be accounted for, the terms a1 and a2 in the above equation are merely replaced by s*a1 and s*a2, where s is the change of scale caused by the change in zoom.

Preferably, the aforementioned RANSAC algorithm is used to estimate the parameters of this rotation-translation approximation. Using the non-zoom approximation, only four terms, a1, a2, tx and ty need be estimated; or, if the zoom approximation is used, the additional term, s, needs to be estimated. Because the time to execute the RANSAC algorithm, and other curve-fitting algorithms, is exponentially proportional to the number of terms being estimated, this coarse approximation of four or five terms can be executed significantly faster than the conventional approximation of the nine matrix terms in the homography matrix M, discussed above.

After the coarse alignment matrix (corresponding to a1, a2, tx, ty, and optionally s) is determined, at 330, based on the low-resolution images L1 and L2, the prior image I2 is aligned to correspond to the current image I1, at 340. That is, in accordance with this aspect of the invention, the estimation of the mis-alignment of the low-resolution images L1 and L2 is used to align the original, higher-resolution images I1 and I2. For ease of reference, it is assumed hereinafter that the prior image I2 is aligned to the current image I1, although alternatively, and equivalently for the purposes of motion estimation, the current image I1 can be aligned to the prior image I2.

At 350, feature points in the coarsely-aligned image I2′ are matched to feature point; in the current image I1. Any of a variety of techniques may be used to identify feature points, typically based on edge and corner detection schemes, common in the art. In a preferred embodiment of this invention, the Minimum Intensity Change (MIC) corner detector as presented in Fast corner detection, Miroslav Trajkovic and Mark Hedley, Image and Vision Computing, 16 (1998) 75-87, and incorporated by reference herein, is used. The MIC corner detector detects changes in intensity along lines passing through a point; the point is determined to be a corner point if the variation in intensity is high for all line orientations. The MIC algorithm also provides an effective balance between performance and speed.

Because the images I2′ and I1 are approximately aligned, the search space for corresponding points between images can be small, and the likelihood of choosing an erroneous corresponding point is minimal. An alignment matrix corresponding to these feature points is determined, at 360, based on high-resolution representations of images I1 and I2′. The images I1 and I2′ may be used directly as these high-resolution representations, or, moderately scaled versions, such as half-scale versions of the images I1 and I2′ may be used to reduce processing complexity, while still retaining substantial resolution. Because the likelihood of error between corresponding points is small, and the resolution of the representations is high, the alignment matrix can be expected to provide a highly accurate and precise set of terms for aligning the images. In a preferred embodiment, the RANSAC algorithm is used to provide the estimated matrix terms of the 3×3 homography matrix, M. The images are aligned based on this highly accurate matrix M, at 370. The current image I1 and its low-resolution representation L1 are saved as the ‘prior’ images, I2 and L2, for use in processing the next image; other parameters related to the current image I1 may also be saved as required, to reduce redundant calculations as each image is compared to a prior image.

Note that the two-stage (low-resolution, then high-resolution) estimation process of this invention provides an inherently more accurate estimate of image alignment parameters than the conventional high-resolution-only process, particularly when relatively large changes in the camera's field of view occur. As noted above, the removal of real-world-moving points from the determination of the image alignment parameters provides for an inherently more accurate estimate of the image-movement caused by camera changes. If the camera-induced movement is large, the ability to discriminate relatively small real-world-movement is substantially degraded, and thus small real-world-movements will introduce errors in the estimation of alignment with large camera changes. With a two-stage process, the small real-world-movements may bias the initial coarse alignment somewhat, but the second stage alignment, using the approximately aligned images, will discriminate the small real-world-movements, because the real-world- stationary points in the approximately aligned images will show a consistency of alignment, or mis-alignment, that substantially differs from the real-world-moving points. This same accuracy improvement will occur with a two-stage high-resolution process, but the use of a low-resolution initial estimation process is preferred, because a low-resolution alignment is generally substantially faster than a high-resolution alignment.

Referring again to the example flow diagram of FIG. 1, after the image is aligned at block 140, using the above described two-stage alignment process, motion detection is performed, at block 150. With aligned images, any of a number of motion detection techniques can be applied, based on changes between the two aligned images. As is known in the art, for example, an exclusive-OR function applied to both images will produce a zero value for identical pixels in both images, and a non-zero value for differing pixel values. A moving object will typically be identified by a grouping of non-zero pixel values. To avoid false-alarms, the size of the grouping is typically required to be above a given threshold value. Copending U.S. patent application “MOTION DETECTION VIA IMAGE ALIGNMENT”, Ser. No. ______, filed ______, for Miroslav Trajkovic, Attorney Docket US010241, and incorporated by reference herein, presents a filtering scheme to further reduce the false identification of image changes as motion effects, based on the image gradient about each point.

Color matching and target identification, at 160-170 is used to distinguish among objects in the aligned images. Copending U.S. patent application “OBJECT TRACKING BASED ON COLOR DISTRIBUTION”, Ser. No. ______, filed ______, for Miroslav Traikovie, Attorney Docket US010238, and incorporated by reference herein, discloses the use of a composite data value corresponds to a chromatic component if the data item (a pixel of an image) is distinguishable from gray, and to a brightness component if the data item is gray, or near gray. In this copending application, the chromatic component is preferably a combination of the measures of hue (color) and saturation (whiteness) of each data item. In the context of this invention, a combination of color matching 160 and motion detection 150 is preferred, so as to allow a tracking system to maintain detection when the tracked object pauses its motion, and to allow for a distinction among a variety of moving objects.

In an automated tracking system, the identification of the target 170 provides location information that facilitates the control 180 of one or more cameras, preferably to keep the target substantially centered in the image, and to maintain a relatively constant focal length to the target. Note, however, that the image alignment technique of this invention is not dependent upon the availability of automated camera control.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A method of aligning a first image to a second image, comprising;
determining a first alignment approximation, based on distances between one or more points in the first image and the second image,
aligning the second image to the first image, based on the first alignment approximation, to form an initially aligned second image,
determining a second alignment approximation, based on distances between one or more points in the first image and the initially aligned second image, and
aligning the second image to the first image, based on a combination of the first and second alignment approximations.

2. The method of claim 1, wherein
aligning the second image to the first image based on the combination of the first and second alignment approximations is effected by:
aligning the initially aligned second image, which is based on the first alignment approximation, to the first image, based on the second alignment approximation.

3. The method of claim 1, wherein
determining the first alignment approximation is based on a low-resolution representation of the first and second images, and
determining the second alignment approximation is based on a higher-resolution representation of the first and second images.

4. The method of claim 1, wherein
determining at least one of the first alignment and second alignment approximations includes applying the RANSAC algorithm.

5. The method of claim 1, wherein
determining the first alignment approximation includes an approximation of at least one of a rotation component and a translation component in an image space of the first and second images.

6. The method of claim 5, wherein
determining the second alignment approximation includes an approximation of components of a 3×3 homographic matrix.

7. The method of claim 1, wherein
determining the second alignment approximation includes an approximation of components of a 3×3 homographic matrix.

8. The method of claim 1, wherein
determining at least one of the first and second alignment approximations includes
identifying corners in the first and second images based on a determination of Minimum Intensity Changes at the corners.

9. A method of tracking an object based on a first image and a second image, comprising:
aligning the first and second images to form a set of aligned images, and
detecting motion by comparing the set of aligned images,
wherein
aligning the first and second images includes;
determining a first alignment approximation, based on distances between one or more points in the first image and the second image,
aligning the second image to the first image, based on the first alignment approximation, to form an initially aligned second image,
determining a second alignment approximation, based on distances between one or more points in the first image and the initially aligned second image, and
aligning the second image to the first image, based on a combination of the first and second alignment approximations.

10. The method of claim 9, wherein
determining the first alignment approximation is based on a low-resolution representation of the first and second images, and
determining the second alignment approximation is based on a higher-resolution representation of the first and second images.

11. The method of claim 9, further including
identifying the object in the set of aligned images based on color matching.

12. The method of claim 9, further including
determining a location of the object in each image of the set of aligned images, and
determining a movement of the object by comparing the location of the object in each image.

13. A motion detecting system comprising:
a processor that is configured to:
align a first image and a second image, to form a set of aligned images, by:
determining a first alignment approximation, based on distances between one or more points in the first image and the second image,
aligning the second image to the first image, based on the first alignment approximation, to form an initially aligned second image,
determining a second alignment approximation, based on distances between one or more points in the first image and the initially aligned second image, and
aligning the second image to the first image, based on a combination of the first and second alignment approximations; and
compare the set of aligned images to identify motion of objects within the first and second images.

14. The motion detecting system of claim 13, wherein
the processor is configured to:
determine the first alignment approximation by processing a low-resolution representation of at least one of the first and second images, and
determine the second alignment approximation by processing a higher-resolution representation of the first and second images.

15. The motion detecting system of claim 13, further including
one or more cameras for producing the first and second images.

16. The motion detecting system of claim 13, further including
a memory for storing a representation of a target image, and
wherein
the processor is further configured to identify a target within the set of aligned images, based on the representation of the target image.

17. The motion detecting system of claim 16, wherein
the representation of the target image is a characterization based on color content of the target image.

18. The motion detecting system of claim 13, further including
determining a location of an object in each image of the set of aligned images, and
determining a movement of the object by comparing the location of the object in each image.

19. The motion detecting system of claim 13, wherein
determining the first alignment approximation includes an approximation of at least one of a rotation component and a translation component.

20. The motion detecting system of claim 19, wherein
determining the second alignment approximation includes an approximation of components of a 3×3 homographic matrix.
